(19) United States
(12) Patent Application Publication
(10) Pub. No.: US 2015/0048116 A1
(43) Pub. Date: Feb. 19, 2015

(54) WATER SERVER

(71) Applicant: KAbushiki Kaisha Cosmo Life, Hyogo (JP)

(72) Inventor: Yoshinori Orita, Hyogo (JP)

(21) Appl. No.: 14/386,865

(22) PCT Filed: Mar. 25, 2013
(86) PCT No.: PCT/JP2013/058536

§ 371 Date: Sep. 22, 2014

(30) Foreign Application Priority Data
Mar. 23, 2012 (JP) 2012-066759

(51) Int. Cl. B67D 3/00; B67D 1/00

(52) U.S. Cl. CPC B67D 3/0009; B67D 1/0009; B67D 3/0022; B67D 3/0029
USPC 222/145.1; 222/146.1

(57) ABSTRACT

A water dispenser is provided which allows air in a warm water tank to be discharged through a tank connecting line when introducing drinking water into the empty warm water tank. The water dispenser includes a check valve (20) provided in the tank connecting line (7), through which a cold water tank (2) is connected to the warm water tank (3). The check valve (20) includes a valve body (22) having a specific gravity smaller than that of drinking water, and is configured such that while there is no drinking water in the valve sleeve (21), the valve body (22) is moved downward by gravity such that the valve hole (25) opens, and such that while the interior of the valve sleeve (21) is filled with drinking water, the valve body (22) moves upward due to buoyancy until the valve hole (25) is closed by the valve body (22).

### TECHNICAL FIELD

This invention relates to a water server (i.e., water dispenser) which is capable of supplying drinking water, such as mineral water, in an exchangeable raw water container.

### BACKGROUND ART

Conventional water dispensers were used mainly in places other than private homes such as in offices and hospitals. However, with the growing interest in safety of water and in health, the number of water dispensers used in private homes is increasing these days.

A typical known home-use water dispenser includes a cold water tank in which drinking water is stored and a warm water tank located under the cold water tank and connected to the cold water tank through a tank connecting line (see e.g. the below-identified Patent document 1).

This water dispenser is ordinarily transported to the place where the water dispenser is intended to be used, with the cold water tank and the warm water tank empty. After placing the water dispenser at the intended use site, an exchangeable raw water container is connected to the water dispenser. As a result, drinking water in the raw water container is introduced into the cold water tank until drinking water in the cold water tank reaches a predetermined level. Drinking water supplied into the cold water tank is partially introduced into the warm water tank through the tank connecting line until the warm water tank is filled with drinking water.

Drinking water in the cold water tank is then kept at a low temperature by the cooling device attached to the cold water tank, while drinking water in the warm water tank is kept at a high temperature by the heating device provided in the warm water tank. When high-temperature drinking water in the warm water tank is discharged into e.g. a cup, drinking water is introduced into the warm water tank from the cold water tank by the same amount as the amount of water discharged, so that the warm water tank is always filled with drinking water.

Since the higher the temperature of drinking water, the lower its specific gravity is, and since drinking water in the warm water tank, which is located at a lower level than the cold water tank, is higher in temperature than drinking water in the cold water tank, convection of drinking water tends to occur in the tank connecting line through which the cold water tank is connected to the warm water tank. Due to such convection, drinking water in the warm water tank could flow into the cold water tank. While the amount of drinking water that could flow from the warm water tank into the cold water tank due to such convection is small, if this phenomenon continues for a long period of time, loss of energy in the cold water tank and the warm water tank tends to be large, which means increased power consumption.

In order to prevent drinking water in the warm water tank from flowing into the cold water tank due to convection in the tank connecting line, the below-described Patent document 1 proposes to provide the tank connecting line of the water dispenser with a check valve which restrains flow of drinking water from the warm water tank toward the cold water tank (see FIG. 2 and paragraph [0020] of Patent document 1).

### PRIOR ART DOCUMENT(S)

### Patent Document(s)

Patent document 1: JP Patent Publication 2009-249033A

### SUMMARY OF THE INVENTION

### Object of the Invention

The inventor of the preset application prepared a water server(water dispenser) in which a check valve is provided in the tank connecting line to restrain flow of drinking water from the warm water tank toward the cold water tank. The check valve used was of an ordinary structure. In particular, the check valve used includes a valve body movable between the open and closed positions, and a spring biasing the valve body from the open position toward the closed position.

By using this check valve, when drinking water in the exchangeable raw water container was introduced into the cold water tank, with both the cold water tank and the warm water tank empty, it was discovered that drinking water in the cold water tank was scarcely introduced into the warm water tank, which could result in the warm water tank being heated with no water in the warm water tank. The reason why this happens is explained now.

When the raw water container is connected to the water dispenser with the cold water tank and the warm water tank both empty, a warm water cock provided in the warm water discharge line extending from the warm water tank is usually kept open. By keeping the warm water cock open, since air in the warm water tank can be discharged to the outside through the warm water discharge line, when drinking water in the raw water container is introduced into the cold water tank, it is possible to introduce drinking water in the cold water tank into the warm water tank too. Thus, when introducing drinking water into the empty warm water tank, it is necessary to keep the warm water tank open.

However, when an operator connects the raw water container to the water dispenser with the cold water tank and the warm water tank both empty, the operator may forget to open the warm water cock. In this case, since the warm water cock is closed, air in the warm water tank cannot be discharged through the warm water discharge line. Also, since there is the check valve in the tank connecting line, which restrains flow of air or water from the warm water tank toward the cold water tank, air in the warm water tank cannot be discharged through the tank connecting line, either. Thus, if drinking water in the raw water container is introduced into the cold water tank in this state, drinking water in the cold water tank is scarcely introduced into the warm water tank. When the heater is activated in this state, the warm water tank will be heated with no water in the warm water tank.

If the warm water tank is heated even once with no water in it, when drinking water is introduced into the warm water tank thereafter, odor may be transferred to drinking water in the warm water tank, or the taste of water in the warm water tank may deteriorate.

While considering this problem, the inventor of the present application discovered that even if there is a check valve in the tank connecting line which restricts flow of water or air from the warm water tank toward the cold water tank, it is still possible to prevent the warm water tank from being heated with no water in it, only if air in the warm water tank can be discharged through the tank connecting line when introducing drinking water into the empty warm water tank.

An object of the present invention is to provide a water dispenser which allows air in the warm water tank to be discharged through the tank connecting line when introducing drinking water into the empty warm water tank.

### Means for Achieving the Object

In order to achieve this object, the present invention provides a water dispenser comprising an upper tank which is capable of holding drinking water therein, a warm water tank provided below the upper tank, a heater for heating drinking water in the warm water tank, a tank connecting line through which the upper tank is connected to the warm water tank, and

a check valve provided in the tank connecting line and configured to permit flow of drinking water from the upper tank toward the warm water tank and restrain flow of drinking water from the warm water tank toward the upper tank,

wherein the check valve comprises a vertically extending hollow tubular valve sleeve, a valve body vertically movably mounted in the valve sleeve, and a valve seat provided over the valve body and formed with a valve hole extending vertically through the valve seat,

wherein the valve body has a specific gravity smaller than the specific gravity of drinking water, and

wherein the check valve is configured such that while there is no drinking water in the valve sleeve, the valve body is moved downward by gravity such that the valve hole opens, and

such that while the interior of the valve sleeve is filled with drinking water, the valve body moves upward due to buoyancy until the valve hole is closed by the valve body.

With this arrangement, while the warm water tank is empty, since the valve body of the check valve is moved downward by gravity, thus opening the valve hole, air is allowed to pass through the check valve from the side of the warm water tank toward the cold water tank. Thus, it is possible to discharge air in the warm water tank into the upper tank through the tank connecting line when introducing drinking water into the empty warm water tank. When the warm water tank becomes filled with water, the valve body of the check valve is moved upward by buoyancy until the valve hole is closed. It is thus possible to prevent drinking water in the warm water tank from flowing into the upper tank due to convection in the tank connecting line.

When drinking water is introduced into the empty warm water tank, if the amount of drinking water flowing into the warm water tank is larger than the amount of air leaving the warm water tank, the air pressure in the warm water tank will rise. In such a case, the valve body of the check valve could be kept pressed against the valve seat under the air pressure in the warm water tank, thus stopping the flow of drinking water from the cold water tank into the warm water tank.

To avoid this problem, the check valve preferably has a communication passage through which a region on one side of the valve seat communicating with the upper tank communicates with a region on the other side of the valve seat communicating with the warm water tank while the valve hole is closed by the valve body. With this arrangement, it is possible to prevent the valve body of the check valve from being pressed against the valve seat when drinking water is introduced into the empty warm water tank. This in turn makes it possible to introduce drinking water into the warm water tank in a stable manner.

In another preferred arrangement, the check valve further comprises a retainer configured to restrain downward stroke of the valve body, and the valve body is a spherical member having a diameter smaller than the distance by which the valve body moves from the position where the valve body is in contact with the retainer to the position where the valve hole is closed by the valve body. With this arrangement too, it is possible to prevent the valve body of the check valve from being pressed against the valve seat when drinking water is introduced into the empty warm water tank, so that drinking water can be introduced into the warm water tank in a stable manner.

In a further preferred embodiment, the tank connecting line includes an in-tank pipe extending downwardly from the top surface of the warm water tank so as to open at a position in the vicinity of the bottom surface of the warm water tank, and the in-tank pipe is formed with a small hole at a position in the vicinity of the top surface of the warm water tank such that the interior and the exterior of the in-tank pipe communicate with each other through the small hole. With this arrangement, since air in the warm water tank flows through the above-described small hole, which is formed in the in-tank pipe at a position in the vicinity of the top surface of the warm water tank, into the tank connecting line, when drinking water is introduced into the empty warm water tank, even when the water level in the warm water tank is high, air in the warm water tank can be smoothly discharged.

### Advantages of the Invention

Since the water dispenser according to the present invention is configured such that while there is no drinking water in the valve sleeve of the check valve, the valve body of the check valve moves downward by gravity, thereby opening the valve hole, air is allowed to flow through the check valve from the side of the warm water tank toward the upper tank. Thus, it is possible to discharge air in the warm water tank into the upper tank through the tank connecting line when drinking water is introduced into the empty warm water tank. When the interior of the valve sleeve of the check valve becomes filled with drinking water, the valve body of the check valve is moved up due to buoyancy, thereby closing the valve hole. Thus, once the warm water tank is filled with high-temperature drinking water, it is possible to prevent drinking water in the warm water tank from flowing into the cold water tank due to convection in the tank connecting line.

### BRIEF DESCRIPTION OF THE DRAWINGS

FIG. 1 is a side view of a water dispenser embodying the present invention.

FIG. 2 is an enlarged sectional view of a check valve shown in FIG. 1.

FIG. 3 is an enlarged sectional view of the check valve of FIG. 2, showing the state in which drinking water is flowing through the check valve from the cold water tank toward the warm water tank.

FIG. 4 is an enlarged sectional view of the check valve of FIG. 2, showing the state in which there is no water in a valve sleeve of the check valve.

FIG. 5 is a plan view of the check valve shown in FIG. 2.

FIG. 6 shows the water dispenser shown in FIG. 1 with a cold water tank and a warm water tank both empty.

FIG. 7 shows how drinking water is introduced into the cold water tank and the warm water tank shown in FIG. 6.

FIG. 8 shows a check valve which is identical to the check valve of FIG. 2 except that there is no communication passage.

FIG. 9 shows a check valve which is identical to the check valve of FIG. 8 except that there is the communication passage.

FIG. 10 shows how drinking water in a raw water container shown in FIG. 1 is drawn out with a pump when water remaining in the raw water container becomes scarce.

FIG. 11 shows the state in which drinking water in the raw water container shown in FIG. 1 has run out.

FIG. 12 shows a modification in which a rigid raw water container is used instead of the raw water container shown in FIG. 1.

FIG. 13 is an enlarged sectional view showing a modification of the communication passage shown in FIG. 2.

FIG. 14 is a plan view of the check valve shown in FIG. 13.

FIG. 15 is an enlarged sectional view showing a modification of the check valve shown in FIG. 4.

### BEST MODE FOR EMBODYING THE INVENTION

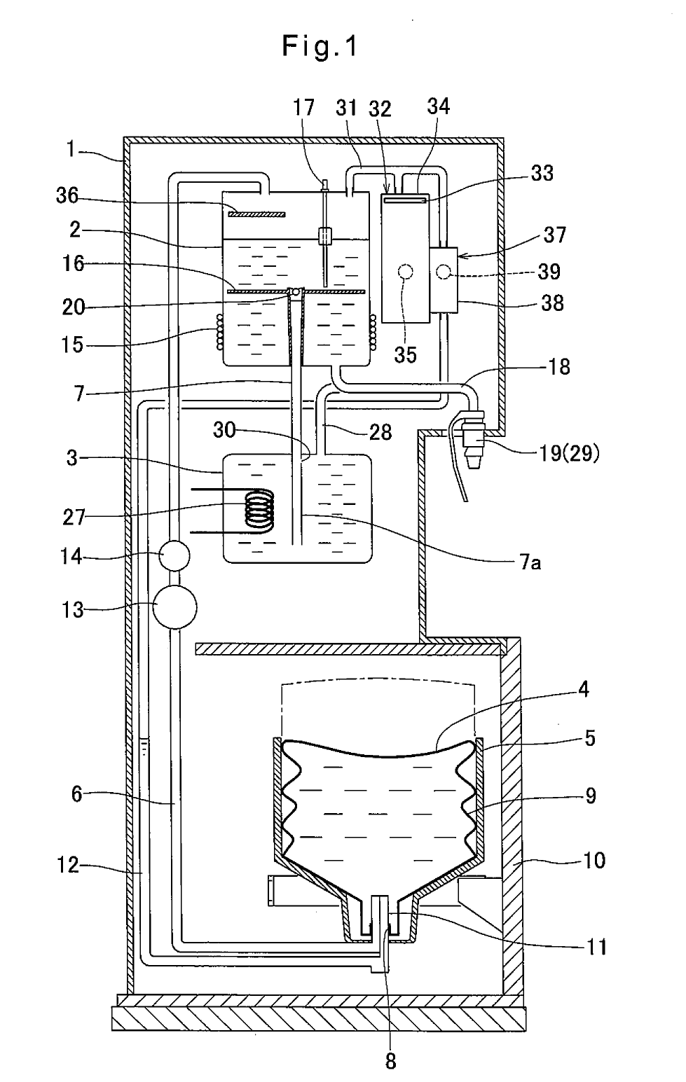

FIG. 1 shows a water server (water dispenser) embodying the present invention. The water dispenser includes a casing 1, and a cold water tank 2 and a warm water tank 3 both mounted in the casing 1. The water dispenser further includes a container holder 5, an exchangeable raw water container 4 configured to be set in the container holder 5, a raw water supply line 6 through which the raw water container 4 is in communication with the cold water tank 2, and a tank connecting line 7 through which the cold water tank 2 is connected to the warm water tank 3. The cold water tank 2 and the warm water tank 3 are vertically aligned with each other with the warm water tank 3 located below the cold water tank 2.

The raw water container 4 has a water outlet 8 and set in the container holder 5 with the water outlet 8 facing downward. The raw water container 4 has a flexible trunk 9 so that the raw water container 4 is gradually collapsible as the water remaining in the container 4 decreases. The raw water container 4 can be formed by blow-molding e.g. polyethylene terephthalate (PET) resin or polyethylene (PE) resin. The raw water container 4 can hold up to about 8 to 20 liters of water.

In order to allow easy exchange of the raw water container 4 with a new one, the container holder 5 is mounted on a slide table 10 horizontally slidably supported by the casing 1 such that the container holder 5 can be slid into and out of the casing 1. The container holder 5 is provided with a joint member 11 configured to be detachably connected to the water outlet 8 of the raw water container 4 when the raw water container 4 is set in the container holder 5. The joint member 11 is a vertically extending hollow tubular member. The raw water supply line 6 is connected at its first end which is closer to the raw water container 4 to the bottom end of the joint member 11. The water dispenser further includes an air intake line 12 through which air can be introduced into the raw water container 4. The air intake line 12 is also connected, at its first end which is closer to the raw water container 4, to the bottom end of the joint member 11.

A pump 13 and a flow rate sensor 14 are mounted to an intermediate portion of the raw water supply line 6. The pump 13 is a gear pump including a pair of gears meshing with each other and configured to feed drinking water by rotating the gears. However, as the pump 13, a diaphragm pump may be used instead which includes a diaphragm and is configured to draw and discharge drinking water by reciprocating the diaphragm. When the pump 13 is activated, drinking water in the raw water container 4 is transferred toward the cold water tank 2 and is supplied into the cold water tank 2. When drinking water in the raw water supply line 6 runs out, the pump 13 feeds air in the raw water supply line (including ozone-containing air) from the side of the raw water container 4 toward the cold water tank 2. The flow rate sensor 14 is capable of detecting the fact that water in the raw water supply line 6 has run out while the pump 13 is activated.

In the cold water tank 2, air and water are stored in two layers, with air forming the top layer. A cooling device 15 is mounted to the cold water tank 2 which is configured to cool drinking water stored in the cold water tank 2. A baffle plate 16 is provided in the cold water tank 2 which divides the interior of the cold water tank 2 into upper and lower spaces. The cooling device 15 is provided on the outer periphery of the cold water tank 2 at its lower portion, and configured to keep drinking water at the portion of the interior of the cold water tank 2 below the baffle plate 16 at a low temperature (about 5° C.).

The cold water tank 2 is provided with a water level sensor 17 which detects the level of drinking water stored in the cold water tank 2. When the water level as detected by the water level sensor 17 falls, the pump 13 is activated to supply water into the cold water tank 2 from the raw water container 4. The baffle plate 16 prevents low-temperature drinking water that has been cooled by the cooling device 15 and has collected at the lower portion of the cold water tank 2 from being stirred by normal-temperature drinking water that has been supplied into the cold water tank 2 from the raw water container 4.

A cold water discharge line 18 is connected to the bottom surface of the cold water tank 2 through which low-temperature drinking water at the lower portion of the cold water tank 2 can be discharged to the outside. The cold water discharge line 18 carries a cold water cock 19 which is operable from outside the casing 1. By opening the cold water cock 19, low-temperature drinking water can be discharged from the cold water tank 2 into e.g. a cup. The capacity of the cold water tank 2 is smaller than that of the raw water container 4 and is about 2 to 4 liters.

The cold water tank 2 and the warm water tank 3 are connected together through a tank connecting line 7 having a top end open at the center of the baffle plate 16. The tank connecting line 7 extends vertically in a straight line between the bottom surface of the cold water tank 2 and the top surface of the warm water tank 3. The tank connecting line 7 has an end portion located in the cold water tank 2, which extends through the bottom of the cold water tank 2 and then upwardly in the cold water tank 2, and is connected to the baffle plate 16. A check valve 20 is provided at this end portion which allows drinking water to flow from the cold water tank 2 toward the warm water tank 3 and restrains drinking water from flowing from the warm water tank 3 toward the cold water tank 2.

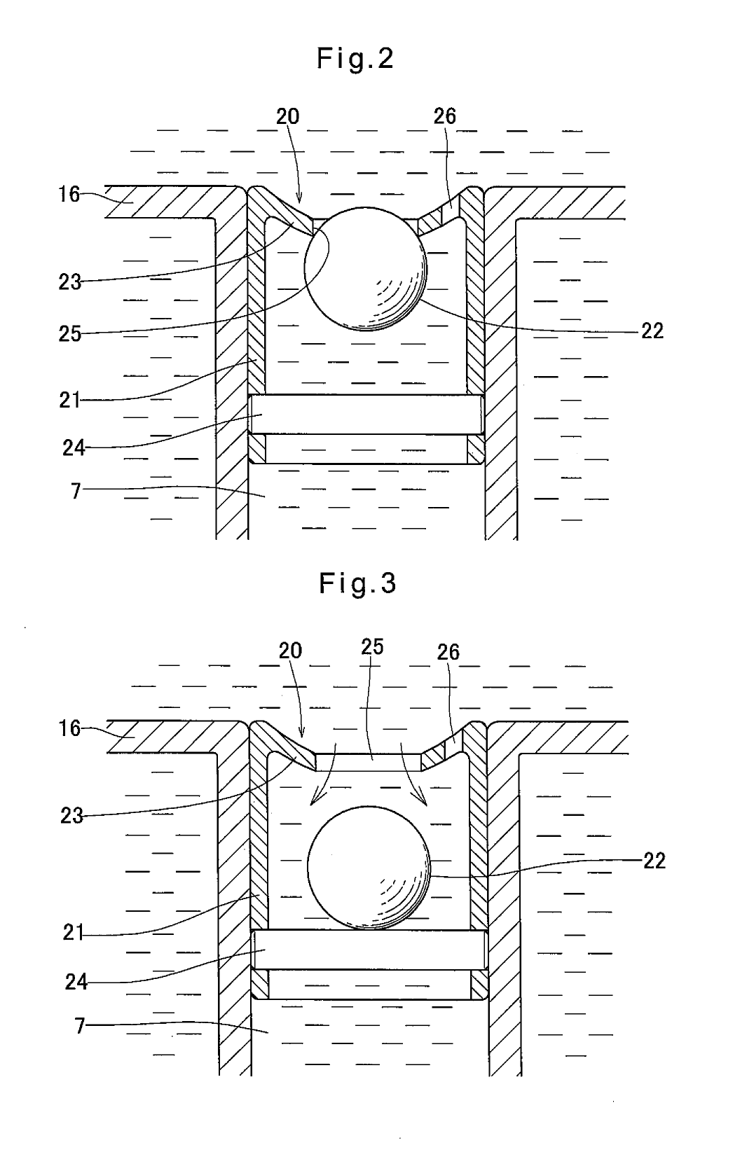

As shown in FIG. 2, the check valve 20 includes a vertically extending hollow tubular valve sleeve 21, a valve body 22 vertically movably received in the valve sleeve 21, a valve seat 23 provided over the valve body 22, and a retainer 24 which restricts the downward stroke of the valve body 22. The valve sleeve 21 is inserted in and fixed to the end of the tank connecting line 7 which opens to the center of the baffle plate 16.

The valve seat 23 has at its center a valve hole 25 extending vertically therethrough. The valve seat 23 is a flange portion radially inwardly extending from the valve sleeve 21. The valve hole 25 is defined by a circular edge and thus circular in shape.

The valve body 22 is made of a resin having a lower specific gravity than drinking water (such as polypropylene (PP) resin) so as to float on drinking water. Thus, when the interior of the valve sleeve 21 is filled with drinking water, the valve body 22 moves upward due to its buoyancy until brought into contact with the valve seat 23, closing the valve hole 25. The valve body 22 is spherically shaped so that the valve body 22 can stably close the valve hole 25 when the valve body 22 is moved upward in the valve sleeve 21, irrespective of its orientation. The valve body 22 has a diameter larger than that of the valve hole 25.

With the interior of the valve sleeve 21 filled with drinking water, when the pressure at the upper side of the valve seat 23 (i.e. its side facing the cold water tank 2) becomes higher than the pressure at the lower side of the valve seat 23 (its side facing the warm water tank 3), as shown in FIG. 3, the valve body 22 moves away from the valve seat 23 and opens the valve hole 25, thus allowing drinking water to flow from the upper side to the lower side. Conversely, when the pressure at the lower side of the valve seat 23 becomes higher than the pressure at the upper side of the valve seat 23, the valve body 22 is pressed against the valve seat 23, so that the valve hole 25 remains closed, preventing drinking water from flowing from the lower side to the upper side.

The check valve 20 has no spring for biasing the valve body 22 from the open position toward the closed position. Thus, when there is no drinking water in the valve sleeve 21, the valve body 22 moves downward and away from the valve seat 23 by gravity, thus opening the valve hole 25. This means that when there is no drinking water in the valve sleeve 21, air is allowed to pass through the check valve 20 from under to over the check valve 20.

The retainer 24 comprises a single rod extending diametrically across the valve sleeve 21. The two flow surface areas divided by such a retainer 24 are both sufficiently large, so that the surface tension of water has little influence on the flow of air around the retainer 24 when drinking water and air flow through the check valve 20.

Referring to FIGS. 2 and 5, the valve seat 23 is formed with a communication passage 26 through which the region above the valve seat 23 (region communicating with the cold water tank 2) is in communication with the region below the valve seat 23 (region communicating with the warm water tank 3), with the valve hole 25 closed by the valve body 22. The communication passage 26 is a hole vertically extending through the valve seat 23 at a position spaced from the valve hole 25. The communication passage 26 has a flow area smaller than the area of the opening of the valve hole 25.

As shown in FIG. 1, the warm water tank 3 is filled with drinking water. A heater 27 is mounted to the warm water tank 3 to heat drinking water in the warm water tank 3, thereby keeping drinking water in the warm water tank 3 at high temperature (about 90° C.). The heater 27 shown is a sheath heater, but the heater according to the present invention may be a band heater. The sheath heater includes a metal pipe in which is mounted a heating wire configured to heat up when energized, and is mounted to the warm water tank 3 to extend through the peripheral wall of the tank 3 into the tank 3. A band heater is a cylindrical heating member in which is embedded a heating wire which heats up when energized. If a band heater is used as the heater 27, it is mounted on the outer periphery of the warm water tank 3 so as to be in close contact with the tank 3.

A warm water discharge line 28 is connected to the top surface of the warm water tank 3 so that high-temperature drinking water that has collected at the upper portion of the warm water tank 3 can be discharged to the outside through the warm water discharge line 28. The warm water discharge line 28 carries a warm water cock 29 which can be operated from outside the casing 1 so that by opening the cock 29, high-temperature drinking water in the warm water tank 3 can be discharged into e.g. a cup. Every time drinking water is discharged from the warm water tank 3, the same amount of drinking water as the water discharged flows from the cold water tank 2 into the warm water tank 3 through the tank connecting line 7, so that the warm water tank 3 is completely filled with water at all times. The warm water tank 3 has a capacity of about 1 to 2 liters.

The tank connecting line 7 includes an in-tank pipe 7a extending from the top surface of the warm water tank 3 downwardly through the interior of the warm water tank 3. The in-tank pipe 7a has an open bottom end located in the vicinity of the bottom surface of the warm water tank 3 (at a location upwardly spaced from the inner bottom surface of the warm water tank 3 by not more than 30 mm). This arrangement prevents high-temperature drinking water heated by the heater 27 and flowing upward from directly flowing into the open bottom end of the in-tank pipe 7a.

A small hole 30 is formed in the in-tank pipe 7a at its portion in the vicinity of the top surface of the warm water tank 3. The small hole 30 is arranged such that its peripheral edge is at least partially downwardly spaced from the inner top surface of the warm water tank 3 by not more than 10 mm. The small hole 30 has an opening area smaller than the cross-sectional area of the interior of the in-tank pipe 7a. The small hole 30 may be a circular hole with a diameter of 2-4 mm.

Ordinarily, the tank connecting line 7 has a small inner diameter in order to reduce convection of drinking water in the tank connecting line 7 due to the difference in temperature between the cold water tank 2 and the warm water tank 3. In this embodiment, however, the inner diameter of the tank connecting line 7 is preferably set at 9 mm or larger, more preferably at 10 mm or larger, for the following reasons.

If, for example, the inner diameter of the tank connecting line 7 is 8 mm or smaller, when drinking water is introduced from the cold water tank 2 into the warm water tank 3 through the tank connecting line 7, it becomes more difficult to feed air in the warm water tank 3 into the tank connecting line 7, due to the increased influence of surface tension of water. This could make it impossible to discharge air in the warm water tank 3 into the cold water tank 2 through the tank connecting line 7.

On the other hand, by setting the inner diameter of the tank connecting line 7 at 9 mm or larger (preferably 10 mm or larger), since the influence of surface tension of water in the tank connecting line 7 decreases, when drinking water is introduced into the now empty warm water tank 3 from the cold water tank 2 through the tank connecting line 7, air in the warm water tank 3 can smoothly flow into the tank connecting line 7, which in turn makes it possible to smoothly discharge air in the warm water tank 3 through the tank connecting line 7. If, however, the tank connecting line 7 is too large in diameter, this tends to push up the manufacturing cost of the water dispenser. The inner diameter of the tank connecting line 7 is therefore limited to 40 mm or less.

An air sterilizing chamber 32 is connected to the cold water tank 2 through an air introducing line 31. The air sterilizing chamber 32 comprises a hollow case 34 formed with an air intake port 33, and an ozone generator 35 mounted in the case 34. The ozone generator 35 may be a low-pressure mercury lamp capable of converting oxygen in the air into ozone by irradiating the oxygen with ultraviolet light, or may be a silent discharge device capable of converting oxygen between a pair of electrodes covered with insulating material into ozone by applying an AC voltage between the electrodes. The ozone generator 35 of the air sterilizing chamber 32 is configured to be energized and generate ozone at predetermined time intervals such that the case 34 is always filled with ozone.

The air introducing line 31 is configured such that when the water level in the cold water tank 2 decreases, air can be correspondingly introduced into the cold water tank 2 through the air introducing line 31, thereby keeping the interior of the cold water tank 2 at the atmospheric pressure. Since air thus introduced into the cold water tank 2 has passed through the air sterilizing chamber 32 and has been sterilized by ozone, air in the cold water tank 2 is kept clean.

A diffusing plate 36 is mounted in the cold water tank 2 which diffuses drinking water discharged from the raw water supply line 6 before reaching the surface of drinking water which is already stored in the cold water tank 2. The diffusing plate 36 increases the surface area of drinking water discharged from the raw water supply line 6 that is brought into contact with ozone in the air in the cold water tank 2 (which has been fed into the cold water tank 2 from the air sterilizing chamber 32), thereby improving the hygienic quality of drinking water flowing into the cold water tank 2.

An ozone generating device 37 is connected to the end of the air intake line 12 remote from the raw water container 4. The ozone generating device 37 comprises a hollow case 38 having an inlet and an outlet, and an ozone generator 39 mounted in the case 38. The inlet of the case 38 is connected to the air introducing line 31, while the outlet of the case 38 is connected to the air intake line 12. Like the ozone generator 35 of the air sterilizing chamber 32, the ozone generator 39 may be a low-pressure mercury lamp capable of converting oxygen in the air into ozone by irradiating the oxygen with ultraviolet light, or may be a silent discharge device capable of converting oxygen between a pair of electrodes covered with insulating material into ozone by applying an AC voltage between the electrodes. The ozone generating device 37 is operatively associated with the pump 13 so as to generate ozone while the pump 13 is activated.

The raw water supply line 6 and the air intake line 12 are made of a flexible and ozone-resistant material so that the slide table 10, which supports the container holder 5, can slide in the intended manner and so that ozone generated in the ozone generating device 37 can flow through the lines 6 and 12. Specifically, the raw water supply line 6 and the air intake line 12 may comprise silicon tubes, fluororesin tubes, or fluororubber tubes.

The operation of the water dispenser is now described.

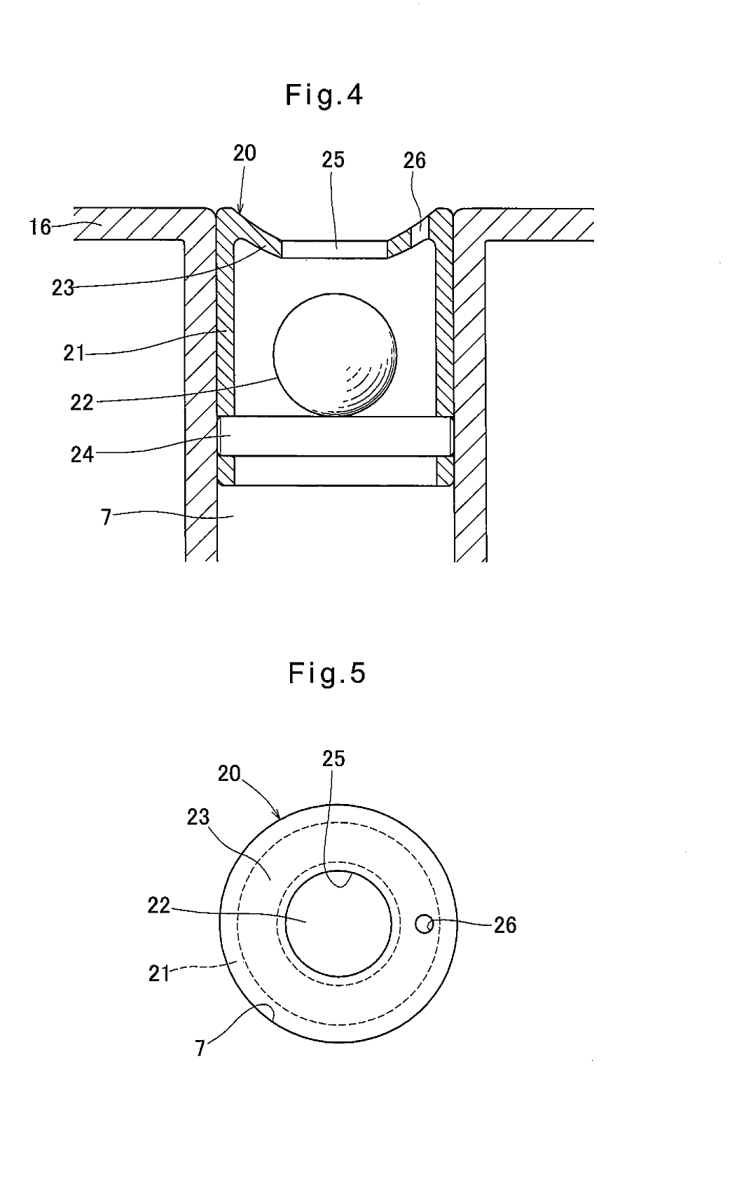

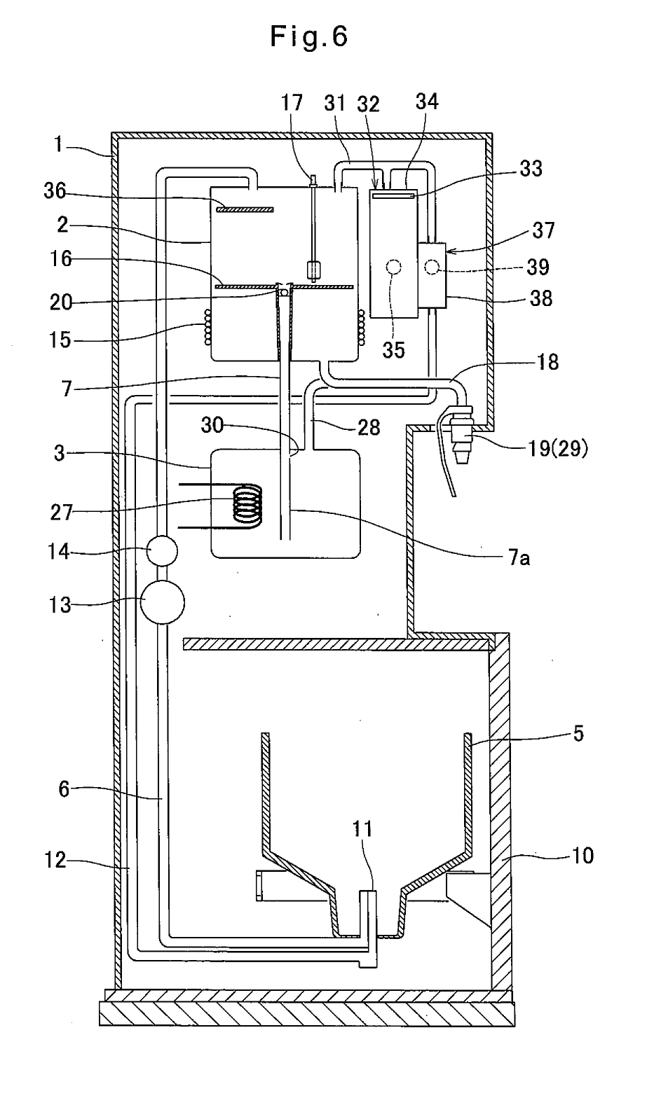

As shown in FIG. 6, the cold water tank 2 and the warm water tank 3 are left empty before the water dispenser is placed in the intended use location (in a private home, office, hospital, etc.). In this state, as shown in FIG. 4, since there is no drinking water in the valve sleeve 21 of the check valve 20, the valve body 22 is separated downwardly by gravity from the valve hole 25, keeping the valve hole 25 open. Air can thus flow through the check valve 20 from under the check valve (its side facing the warm water tank 3) to over the check valve (its side facing the cold water tank 2).

After the water dispenser has been placed in the intended use location, an exchangeable raw water container 4 is connected to the water dispenser. The water dispenser is then connected to a power source to activate the pump 13, thereby introducing drinking water in the raw water container 4 into the cold water tank 2. The water level in the cold water tank 2 thus rises, so that excess air in the cold water tank 2 is expelled to the outside through the air introducing line 31 and then the air sterilizing chamber 32.

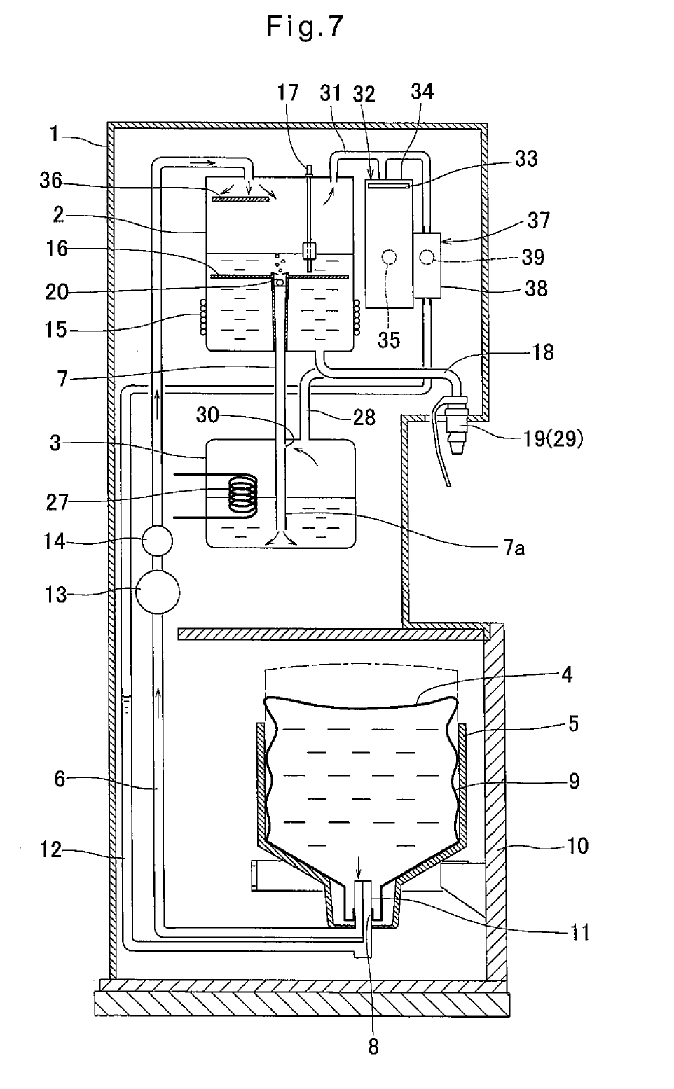

When, as shown in FIG. 7, the water level in the cold water tank 2 exceeds the level of the baffle plate 16 (namely, the level of the tank connecting line 7 facing the cold water tank 2), drinking water in the cold water tank 2 is introduced into the warm water tank 3 through the tank connecting line 7. Simultaneously, air in the warm water tank 3 flows into the tank connecting line 7 through the small hole 30, which is formed in the in-tank pipe 7a at its portion in the vicinity of the top surface of the warm water tank 3, and is discharged through the tank connecting line 7 into the cold water tank 2. That is, drinking water in the cold water tank 2 flows through the tank connecting line 7 and is introduced into the empty warm water tank 3 by replacing air in the warm water tank 3.

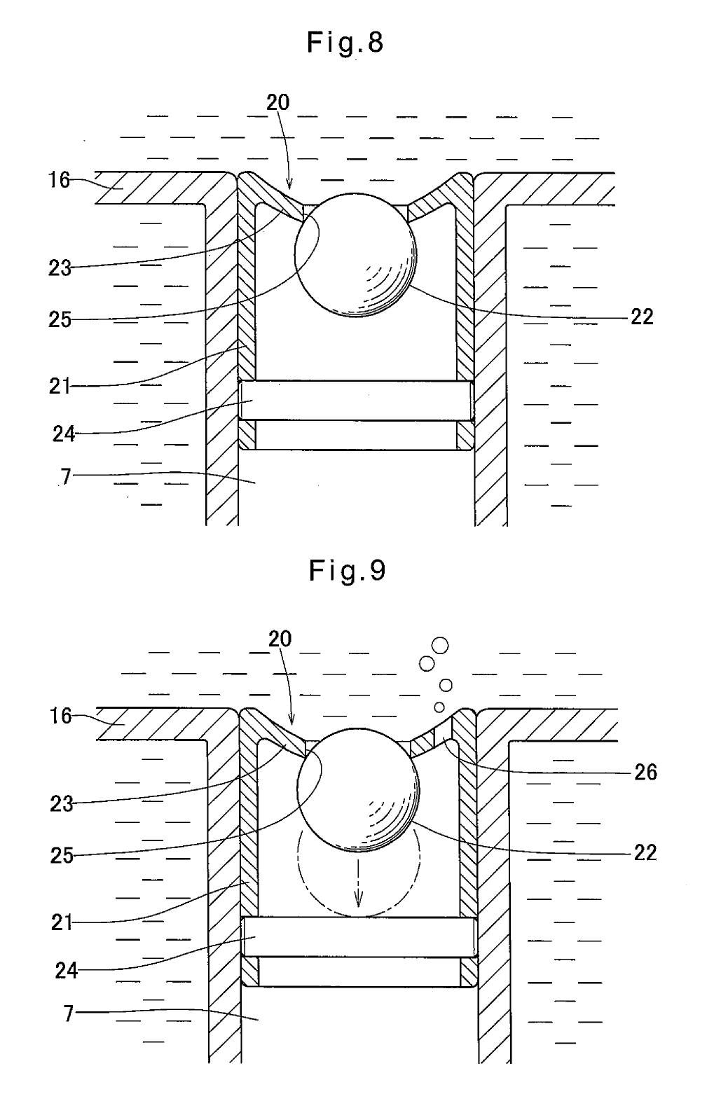

When drinking water is introduced into the empty warm water tank 3, if the amount of drinking water flowing into the warm water tank 3 is larger than the amount of air leaving the warm water tank 3, the air pressure in the warm water tank 3 will rise. In such a case, if there were not the communication passage 26 in the valve seat 23 of the check valve 20 as shown in FIG. 8, the valve body 22 of the check valve 20 would be kept pressed against the valve seat 23 under the pressure in the region under the valve seat 23 (the region facing the warm water tank 3), thus stopping the flow of drinking water from the cold water tank 2 into the warm water tank 3. There is also the possibility that the valve body 22 may be kept pressed against the valve seat 23 due to surface tension of water trapped between the valve body 22 and the valve seat 23.

In contrast, by providing the communication passage 26 in the valve seat 23 of the check valve 20 as shown in FIG. 9, if air pressure in the warm water tank 3 rises when drinking water is introduced into the empty warm water tank 3, pressure in the warm water tank 3 is released into the cold water tank 2 through the communication passage 26. This prevents the valve body 22 of the check valve 20 from being pressed against the valve seat 23, thus making it possible to introduce drinking water into the warm water tank 3 in a stable manner.

When, thereafter, the water level in the cold water tank 2 reaches a predetermined upper limit shown in FIG. 1, the pump 13 is deactivated. In this state, drinking water in the cold water tank 2 is cooled and kept at a low temperature by the cooling device 15, while drinking water in the warm water tank 3 is heated and kept at a high temperature by the heater 27. While drinking water filling the warm water tank 3 is thermally expanded when heated from normal to high temperature by the heater 27, since, in this state, pressure in the warm water tank 3 is released into the cold water tank 2 through the communication passage 26, the warm water tank 3 is protected against cracks and deformation due to thermal expansion of drinking water.

Since the warm water tank 3 is located below the cold water tank 2, and the temperature of drinking water in the warm water tank 3 is higher than the temperature of drinking water in the cold water tank 2, convection of drinking water occurs in the tank connecting line 7, which connects together the cold water tank 2 and the warm water tank 3. If there were not the check valve 20 in the tank connecting line 7, drinking water in the warm water tank 3 could flow into the cold water tank 2 due to convection of drinking water in the tank connecting line 7.

In contrast, as shown in FIGS. 1 and 2, by providing the check valve 20 in the tank connecting line 7, which restrains the flow of drinking water from the warm water tank 3 toward the cold water tank 2, the check valve 20 prevents drinking water in the warm water tank 3 from flowing into the cold water tank 2 due to convection in the tank connecting line 7, thereby preventing loss of energy both in the cold water tank 2 and the warm water tank 3. Even while the valve hole 25 is closed by the valve body 22, the region above the valve seat 23, i.e. the region communicating with the cold water tank 2, is in communication with the region below valve seat 23, i.e. the region communicating with the warm water tank 3, through the communication passage 26. However, since the flow area of the communication passage 26 is significantly small compared to the flow area of the tank connecting line 7, drinking water in the warm water tank 3 scarcely flows into the cold water tank 2 through the communication passage 26.

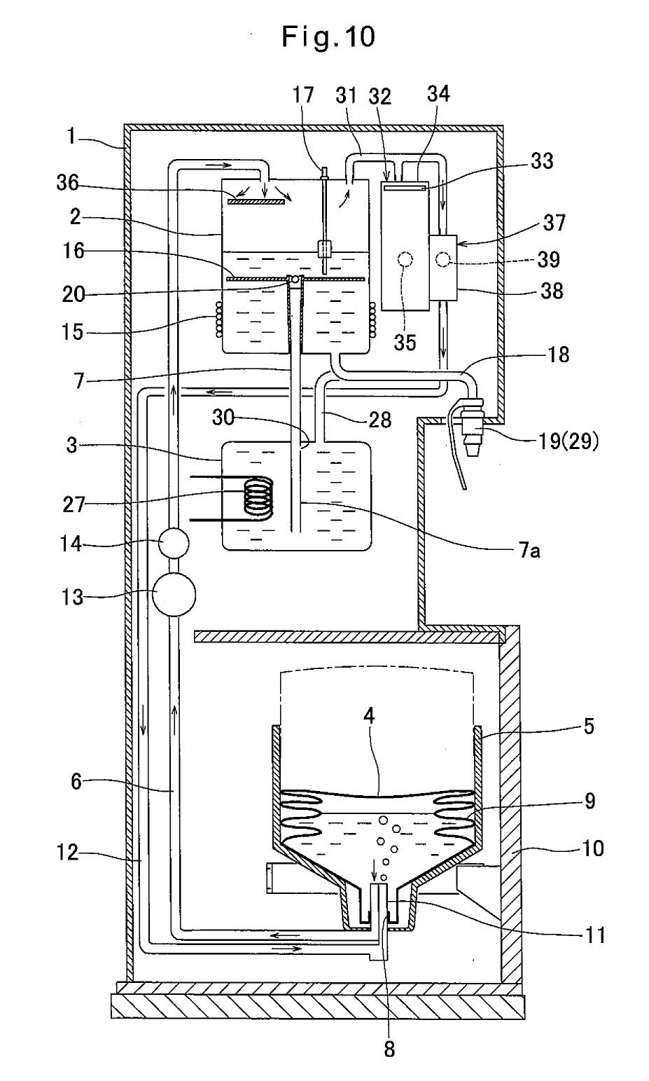

When, thereafter, a user of the water dispenser discharges low-temperature drinking water in the cold water tank 2 into e.g. a cup by operating the cold water cock 19, the water level in the cold water tank 2 falls. When the user discharges high-temperature drinking water in the warm water tank 3 into e.g. a cup by operating the warm water cock 29, too, since the same amount of drinking water as the drinking water discharged is introduced into the warm water tank 3 from the cold water tank 2 through the tank connecting line 7, the water level in the cold water tank 2 falls. When the water level sensor 17 detects that the water level in the cold water tank 2 drops below a predetermined lower limit, the pump 13 is activated to supply drinking water in the raw water container 4 into the cold water tank 2 as shown in FIG. 10. Simultaneously, the ozone generating device 37 is activated to generate ozone.

While the pump 13 is activated with a relatively large amount of water remaining in the raw water container 4 as shown in FIG. 1, the raw water container 4 collapses under the atmospheric pressure as drinking water in the raw water container 4 decreases. Thus, in this state, no air flows into the raw water container 4 through the air intake line 12.

When water remaining in the raw water container 4 becomes scarce as shown in FIG. 10, the raw water container 4 has been collapsed to such a degree that the container 4 is scarcely collapsible any further due to its increased rigidity. Thus, when the pump 13 is activated in this state, the pressure in the raw water container 4 decreases, and as a result, air flows into the raw water container 4 through the air intake line 12. In this state, since ozone is being generated by the ozone generating device 37, the ozone thus generated flows through the air intake line 12 and then the joint member 11 into the raw water container 4, sterilizing the interior of the air intake line 12 and the interior of the joint member 11.

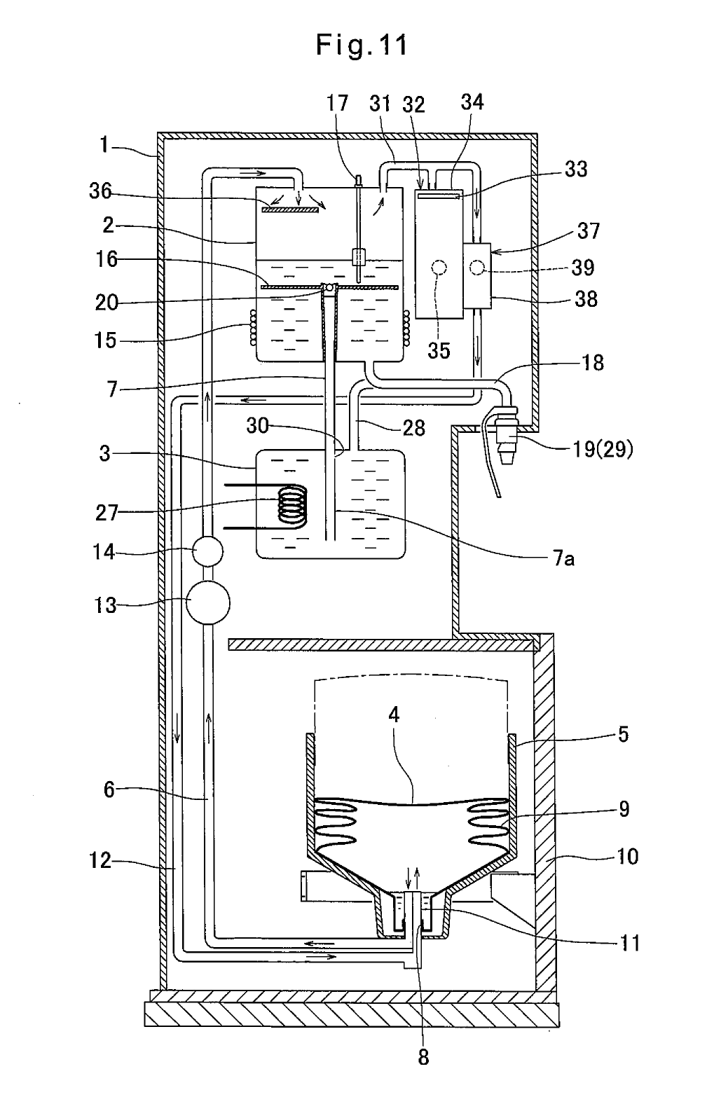

As shown in FIG. 11, when the flow rate sensor 14 detects that drinking water in the raw water supply line 6 has run out while the pump 13 is activated, the pump 13 and the ozone generating device 37 are configured to be continuously operated for a predetermined time period from this point of time. In this state, ozone generated by the ozone generating device 37 flows through the air intake line 12 and then through the joint member 11 into the lower portion of the raw water container 4, and then from the lower portion of the raw water container 4, ozone flows through the joint member 11 and then through the raw water supply line 6 into the cold water tank 2. Thus, it is possible to sterilize the interior of the air intake line 12, the interior of the joint member 11, and the interior of the raw water supply line 6, with ozone.

When there is no drinking water in the valve sleeve 21 of the check valve 20 during use of the water dispenser, the valve body 22 of the check valve 20 moves downwardly by gravity, thus opening the valve hole 25. This allows passage of air through the check valve 20 from the side of the warm water tank 3 to the side of the cold water tank 2. This in turn makes it possible to discharge air in the warm water tank 3 into the cold water tank 2 through the tank connecting line 7 when drinking water is introduced into the empty warm water tank 3. As a result, it is possible to introduce drinking water in the cold water tank 2 into the warm water tank 3 even while the warm water cock 29 is closed, which in turn prevents the warm water tank 3 from being heated with no water in the tank 3.

When the interior of the valve sleeve 21 of the check valve 20 becomes filled with drinking water, the valve body 22 of the check valve 20 is moved up due to buoyancy, thereby closing the valve hole 25. Thus, once the warm water tank 3 is filled with high-temperature drinking water, it is possible to prevent drinking water in the warm water tank 3 from flowing into the cold water tank 2 due to convection in the tank connecting line 7.

Further, since the check valve 20 of this water dispenser is provided with the communication passage 26, the valve body 22 of the check valve 20 is prevented from being pressed against the valve seat 23 when drinking water is introduced into the empty warm water tank 3. This makes it possible to introduce drinking water into the warm water tank 3 in a stable manner.

In this water dispenser, since the in-tank pipe 7a is formed with the small hole 30 at its portion near the top surface of the warm water tank 3 such that the interior and the exterior of the pipe 7a communicate with each other, when drinking water is introduced into the empty warm water tank 3 and the water level in the tank 3 increases, it is possible to smoothly discharge air in the warm water tank 3 through the tank connecting line 7.

Since this water dispenser is configured such that the ozone generating device 37 generates ozone while the pump 13 is activated, ozone generated by the ozone generating device 37 flows through the air intake line 12, thereby sterilizing the interior of the air intake line 12, when air flows through the air intake line 12 into the raw water container 4. This prevents growth of bacteria in the air intake line 12, and thus keeps the interior of the air intake line 12 in hygienic conditions.

This water dispenser is further configured such that after drinking water in the raw water container 4 has run out, the pump 13 is continuously activated to allow ozone to be fed through the air intake line 12 and the raw water supply line 6. This means that every time an exchangeable raw water container 4 becomes empty, both the air intake line 12 and the raw water supply line 6 are sterilized with ozone. This keeps the water dispenser in hygienic conditions.

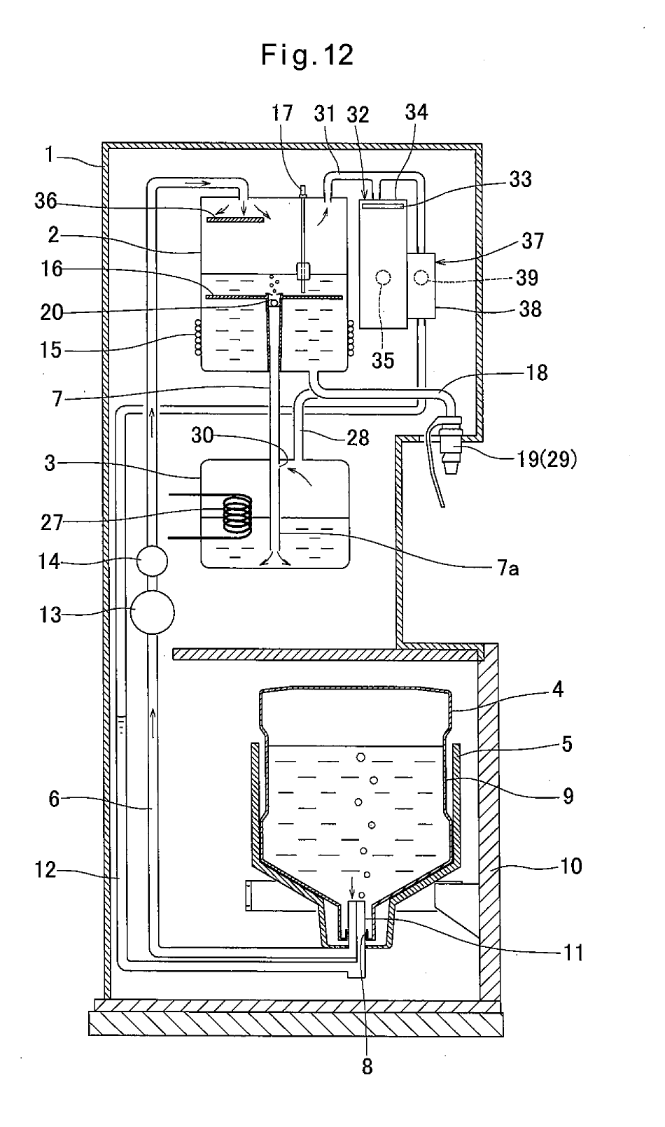

In the above embodiment, the raw water container 4 is collapsible as water remaining in the container 4 decreases. However, as shown in FIG. 12, this invention is also applicable to a water dispenser which uses a raw water container 4 which is not collapsible when water in the container 4 decreases. The raw water container 4 of this embodiment has a trunk portion 9 which is of such rigidity as not to be collapsible when water in the container 4 decreases. Such a rigid raw water container 4 may be formed by blow-molding e.g. polyethylene terephthalate (PET) resin or polycarbonate (PC) resin.

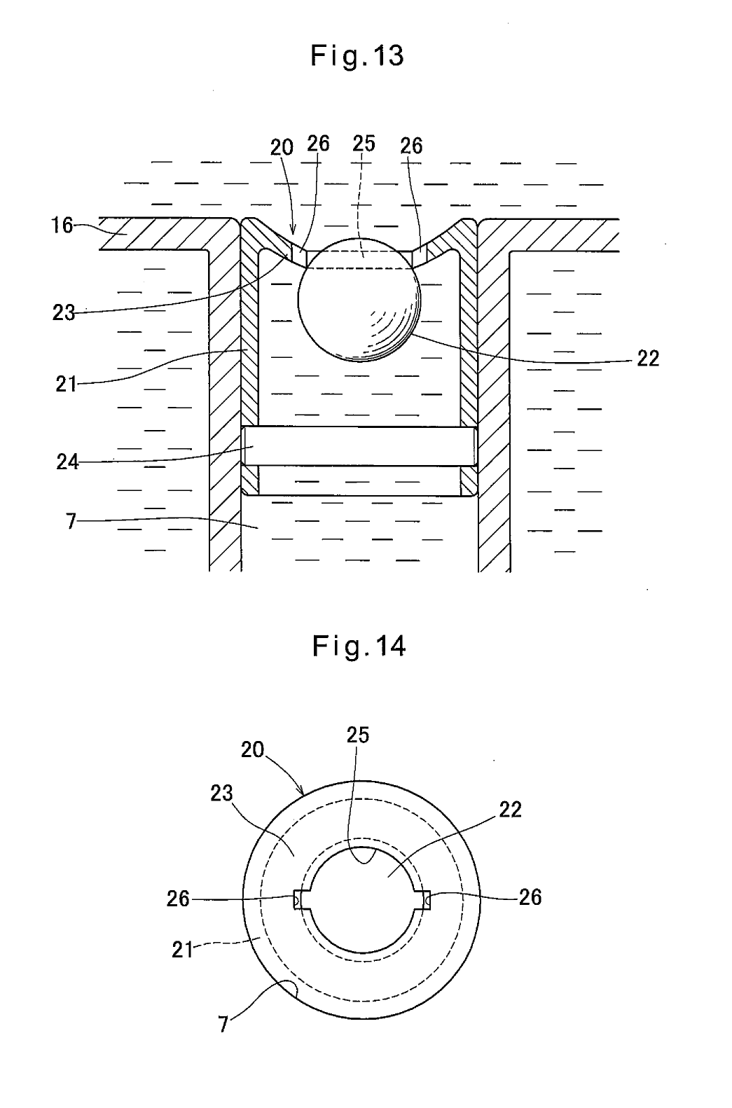

In the above embodiment, the communication passage 26, through which both sides of the valve seat 23 communicate with each other with the valve hole 25 closed by the valve body 22, is a hole extending vertically through the valve seat 23 and spaced from the valve hole 25. Instead, as shown in FIGS. 13 and 14, the communication passage 26 may comprise cutouts formed in the peripheral edge of the valve hole 25. Further alternatively, the communication passage 26 may comprise at least one groove formed in the outer periphery of the valve sleeve 21 to extend from the top end to the bottom end of the valve sleeve 21.

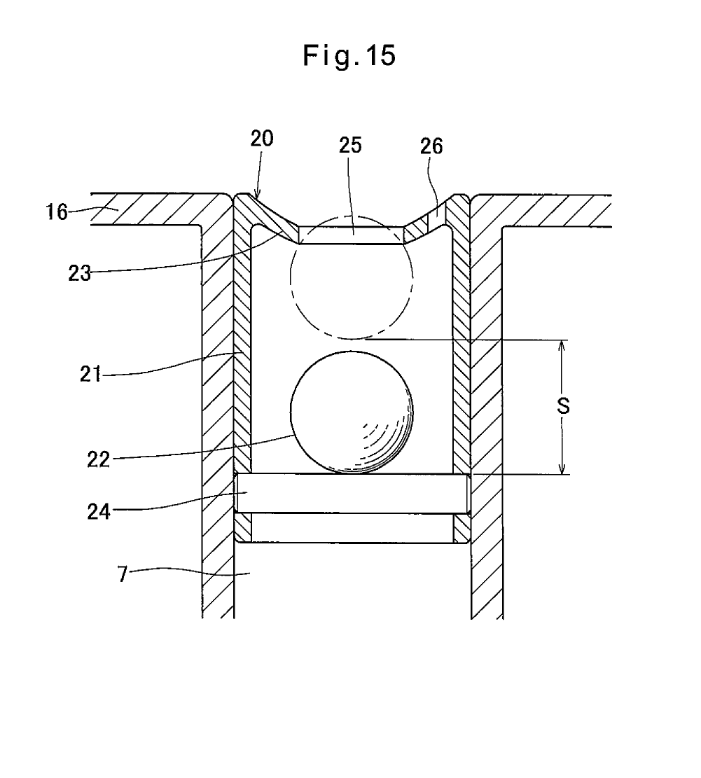

As shown in FIG. 15, the check valve may be configured such that the diameter of the valve body 22 is smaller than the distance S by which the valve body 22 moves vertically from the position where the valve body 22 has moved down by gravity until brought into contact with the retainer 24 when there is no drinking water in the valve sleeve 21 (position shown by solid line) to the position where the valve body 22 is pressed against the valve seat 23, and closes the valve hole 25 (position shown by chain line).

With this arrangement, since the distance by which the valve body 22 moves from the state where the valve body 22 has moved to the lowest position by gravity to the position where the valve hole 25 is closed by the valve body 22 is long, it is possible to prevent the valve body 22 from rising to the position where there is the valve seat 23 when drinking water in the cold water tank is introduced into the empty warm water tank 3 through the check valve 20. This prevents the valve body 22 of the check valve 20 from being pressed against the valve seat 23 when drinking water is introduced into the empty warm water tank 3, thereby making it possible to introduce drinking water into the warm water tank 3 in a stable manner.

The water dispenser of the above embodiment is configured such that the warm water tank 3 is provided below the cold water tank 2, the cold water tank 2 and the warm water tank 3 are connected to each other thorough the tank connecting line 7, and the check valve 20 is provided in the tank connecting line 7. (In other words, in this embodiment, the tank located above the warm water tank is a cold water tank 2.) However, this invention is also applicable to a water dispenser in which the upper tank, i.e. the tank located above the warm water tank 3 is a tank in which water of normal temperature is to be stored. Further alternatively, the present invention is applicable to a water dispenser which includes a normal temperature tank which is configured to receive and store drinking water from an exchangeable raw water container 4, a cold water tank 2 and a warm water tank 3 which are provided below the normal temperature tank with one of the tanks 2 and 3 on the right-hand side of the other. The normal temperature tank is connected to the cold water tank 2 through a cold water tank connecting line, and is connected to the warm water tank 3 through a warm water tank connecting line 7. In this arrangement, a check valve 20 is provided in the warm water tank connecting line 7 to restrain flow of drinking water from the warm water tank 3 toward the normal temperature tank.

### DESCRIPTION OF THE NUMERALS

2. Cold water tank
3. Warm water tank
7. Tank connecting line
7a. In-tank pipe
20. Check valve
21. Valve sleeve
22. Valve body
23. Valve seat
24. Retainer
25. Valve hole
26. Communication passage
27. Heater
30. Small hole

1. A water dispenser comprising an upper tank which is capable of holding drinking water therein, a warm water tank provided below the upper tank, a heater for heating drinking water in the warm water tank, a tank connecting line through which the upper tank is connected to the warm water tank, and
a check valve provided in the tank connecting line and configured to permit flow of drinking water from the upper tank toward the warm water tank and restrain flow of drinking water from the warm water tank toward the upper tank,
wherein the check valve comprises a vertically extending hollow tubular valve sleeve, a valve body vertically movably mounted in the valve sleeve, and a valve seat provided over the valve body and formed with a valve hole extending vertically through the valve seat,
wherein the valve body has a specific gravity smaller than a specific gravity of drinking water, whereby
while there is no drinking water in the valve sleeve, the valve body is moved downward by gravity such that the valve hole opens, and
while an interior of the valve sleeve is filled with drinking water, the valve body moves upward due to buoyancy until the valve hole is closed by the valve body.

2. The water dispenser of claim 1, wherein the check valve has a communication passage through which a region on one side of the valve seat communicating with the upper tank communicates with a region on another side of the valve seat communicating with the warm water tank while the valve hole is closed by the valve body.

3. The water dispenser of claim 1, wherein the check valve further comprises a retainer configured to restrain downward stroke of the valve body, and wherein the valve body is a spherical member having a diameter smaller than a distance by which the valve body moves from a position where the valve body is in contact with the retainer to a position where the valve hole is closed by the valve body.

4. The water dispenser of claim 1, wherein the tank connecting line includes an in-tank extending downwardly from a top surface of the warm water tank so as to open at a position in a vicinity of a bottom surface of the warm water tank, and wherein the in-tank pipe is formed with a small hole at a position in a vicinity of the top surface of the warm water tank such that an interior and an exterior of the in-tank pipe communicate with each other through the small hole.

5. The water dispenser of claim 2, wherein the check valve further comprises a retainer configured to restrain downward stroke of the valve body, and wherein the valve body is a spherical member having a diameter smaller than a distance by which the valve body moves from a position where the valve body is in contact with the retainer to a position where the valve hole is closed by the valve body.

6. The water dispenser of claim 2, wherein the tank connecting line includes an in-tank pipe extending downwardly from a top surface of the warm water tank so as to open at a position in a vicinity of a bottom surface of the warm water tank, and wherein the in-tank pipe is formed with a small hole at a position in a vicinity of the top surface of the warm water tank such that an interior and an exterior of the in-tank pipe communicate with each other through the small hole.

7. The water dispenser of claim 3, wherein the tank connecting line includes an in-tank pipe extending downwardly from a top surface of the warm water tank so as to open at a position in a vicinity of a bottom surface of the warm water tank, and wherein the in-tank pipe is formed with a small hole at a position in a vicinity of the top surface of the warm water tank such that an interior and an exterior of the in-tank pipe communicate with each other through the small hole.

8. The water dispenser of claim 5, wherein the tank connecting line includes an in-tank pipe extending downwardly from a top surface of the warm water tank so as to open at a position in a vicinity of a bottom surface of the warm water tank, and wherein the in-tank pipe is formed with a small hole at a position in a vicinity of the top surface of the warm water tank such that an interior and an exterior of the in-tank pipe communicate with each other through the small hole.
